(19) United States
(12) Patent Application Publication
(10) Pub. No.: US 2026/0365125 A1
(43) Pub. Date: Nov. 19, 2026

(54) VEHICLE-MOUNTED APPARATUS, ACTIVATION CONTROL METHOD, AND ACTIVATION CONTROL PROGRAM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Takuma YAMANE, Yokkaichi-shi, Mie (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 19/137,113

(22) PCT Filed: Nov. 24, 2023
(86) PCT No.: PCT/JP2023/042205

§ 371 Date: Jun. 9, 2025

(30) Foreign Application Priority Data
Dec. 13, 2022 (JP) 2022-198403

(51) Int. Cl. B60R 16/023; H02J 1/08

(52) U.S. Cl. CPC B60R 16/0231; H02J 1/084

(57) ABSTRACT

A vehicle-mounted apparatus is to be used on a vehicle-mounted network including a plurality of vehicle-mounted devices and includes: a selection unit configured to select a power-supplied device, which is a vehicle-mounted device to be supplied with power, out of the plurality of vehicle-mounted devices; an acquisition unit configured to acquire activation method information indicating an activation method of each vehicle-mounted device; and a control unit configured to perform an activation process that activates the power-supplied device selected by the selection unit, based on the activation method information acquired by the acquisition unit.

### CROSS-REFERENCE TO RELATED APPLICATIONS

This application is the U.S. national stage of PCT/JP2023/042205 filed on Nov. 24, 2023, which claims priority of Japanese Patent Application No. JP 2022-198403 filed on Dec. 13, 2022, the contents of which are incorporated herein.

### TECHNICAL FIELD

The present disclosure relates to a vehicle-mounted apparatus, an activation control method, and an activation control program.

### BACKGROUND

JP2013-192108A discloses the following technology. A vehicle-mounted communication system includes: a plurality of communication buses mounted in a vehicle; a plurality of communication devices, which are connected to any one of the plurality of communication buses and transmit and receive information groups in which one or a plurality of pieces of information are grouped together; and a relay device which is equipped with a plurality of communication units, that are connected to each of the plurality of communication buses, and relay information between difference communication buses by transmitting and receiving information groups using the plurality of communication units. The vehicle-mounted communication system is further equipped with one or a plurality of power supply control apparatuses that communicate with the relay apparatus and each perform power supply control of one or a plurality of vehicle-mounted devices, based on information transmitted from the relay apparatus. The relay apparatus includes: storage means for rewritably storing a power supplying state table which indicates, for each of a plurality of vehicle states that are defined in advance for the vehicle, a desired power supplying state for one or a plurality of vehicle-mounted devices in the vehicle state; extraction means for extracting information required by power supply control of the one or plurality of vehicle-mounted devices from each of the one or more received information groups; identification means for identifying the vehicle state, based on the information extracted by the extraction means; deciding means for deciding a desired power status of the one or more vehicle-mounted devices, based on the vehicle status determined by the determination means and the power supplying state table stored in the storage means; creating means for creating an information group including control information indicating the power supplying state decided by the deciding means; and means for transmitting the information group created by the creating means to the power supply control apparatus.

In recent years, there has been a tendency for the number of types of service executed on a vehicle-mounted network to increase. As the number of types of services increases, as examples, vehicle-mounted devices such as ECUs (Electronic Control Units) may be added to the vehicle-mounted network or the connection destinations of vehicle-mounted devices may change. In this way, there is demand for technology that can reliably activate vehicle-mounted devices even when the configuration of a vehicle-mounted network has changed.

The present disclosure was conceived to solve the problems described above, and has an object of providing a relay apparatus, an activation control method, and an activation control program that can reliably activate vehicle-mounted devices in a newly configured vehicle-mounted network.

### SUMMARY

Conventionally, in a vehicle-mounted network including a plurality of vehicle-mounted devices, a technique has been proposed for controlling vehicle-mounted devices in keeping with the state of the vehicle in which the vehicle-mounted network is installed.

A vehicle-mounted apparatus according to an aspect of the present disclosure is a vehicle-mounted apparatus to be used on a vehicle-mounted network including a plurality of vehicle-mounted devices, the vehicle-mounted apparatus including: a selection unit configured to select a power-supplied device, which is a vehicle-mounted device to be supplied with power, out of the plurality of vehicle-mounted devices; an acquisition unit configured to acquire activation method information indicating an activation method of each vehicle-mounted device; and a control unit configured to perform an activation process that activates the power-supplied device selected by the selection unit, based on the activation method information acquired by the acquisition unit.

This aspect of the present disclosure may be realized not only as a vehicle-mounted apparatus equipped with this characteristic processing unit, but also as a semiconductor integrated circuit that realizes part or all of the above vehicle-mounted apparatus, or as a system including the vehicle-mounted apparatus.

### Advantageous Effects

According to the present disclosure, it is possible to reliably activate vehicle-mounted devices on a newly configured vehicle-mounted network.

### BRIEF DESCRIPTION OF DRAWINGS

FIG. 1 is a diagram depicting an example configuration of a vehicle-mounted system according to an embodiment of the present disclosure.

FIG. 2 is a diagram depicting one example configuration of a relay apparatus according to an embodiment of the present disclosure.

FIG. 3 is a diagram depicting an example configuration of a new network in a vehicle-mounted system according to an embodiment of the present disclosure.

FIG. 4 is a diagram depicting another example configuration of a new network in a vehicle-mounted system according to an embodiment of the present disclosure.

FIG. 5 is a diagram depicting one example of a device selection table stored in the relay apparatus according to the embodiment of the present disclosure.

FIG. 6 is a diagram depicting an example of an activation table stored in the relay apparatus according to the embodiment of the present disclosure.

FIG. 7 is a diagram depicting one example of an updated device selection table stored in the relay apparatus according to the embodiment of the present disclosure.

FIG. 8 is a diagram depicting one example of an updated activation table stored in the relay apparatus according to the embodiment of the present disclosure.

FIG. 9 is a diagram illustrating one example of a relay table stored in the relay apparatus according to an embodiment of the present disclosure.

FIG. 10 is a diagram depicting one example of a power supplying priority table stored by the relay apparatus according to an embodiment of the present disclosure.

FIG. 11 is a flowchart defining an operation procedure in which a relay apparatus according to an embodiment of the present disclosure performs an activation process.

### DETAILED DESCRIPTION OF PREFERRED EMBODIMENTS

Several embodiments of the present disclosure will first be listed and described in outline.

In a first aspect, a vehicle-mounted apparatus according to an embodiment of the present disclosure is a vehicle-mounted apparatus to be used on a vehicle-mounted network including a plurality of vehicle-mounted devices, the vehicle-mounted apparatus including: a selection unit configured to select a power-supplied device, which is a vehicle-mounted device to be supplied with power, out of the plurality of vehicle-mounted devices; an acquisition unit configured to acquire activation method information indicating an activation method of each vehicle-mounted device; and a control unit configured to perform an activation process that activates the power-supplied device selected by the selection unit, based on the activation method information acquired by the acquisition unit.

In this way, by activating a power-supplied device selected out of the plurality of vehicle mounted devices using the activation method information, it is possible, even when the configuration of the vehicle-mounted network has changed, to activate the power-supplied device according to the activation method indicated by the activation method information. Accordingly, it is possible to reliably activate vehicle-mounted devices in a newly configured vehicle-mounted network.

As one example, when activating a selected power-supplied device in a newly configured vehicle-mounted network, it is possible to newly acquire activation method information corresponding to the vehicle-mounted network and identify the activation method of the power-supplied device. By doing so, it is possible for the activation method information to be updated to accommodate changes in the configuration of a vehicle-mounted network.

In a second aspect, in the vehicle-mounted apparatus according to the first aspect, the acquisition unit may further acquire characteristics information indicating operating characteristics of each vehicle-mounted device, and the control unit may perform the activation process, based on the activation method information and the characteristics information acquired by the acquisition unit.

With this configuration, when a power-supplied device is activated, it is possible to activate the power-supplied device using an appropriate method which takes into account the operating characteristics of that power-supplied device.

In a third aspect, in the vehicle-mounted apparatus according to the second aspect, the characteristics information may indicate a consumption current of each vehicle-mounted device as the operating characteristics, the selection unit may select a plurality of the power-supplied devices out of the plurality of vehicle-mounted devices, the control unit may select, based on the consumption current of each power supplied device indicated by the characteristics information, a non-power-supplied device, which is a power-supplied device that is not to be supplied power, out of the plurality of power supplied devices, and the control unit may activate identified devices, which are power-supplied devices out of the plurality of power-supplied devices aside from the selected non-power supplied device, according to the activation methods of the identified devices indicated by the activation method information.

With this configuration, it is possible to select a device to which power should not be supplied in keeping with the power consumption of the power-supplied devices.

In a fourth aspect, in the vehicle-mounted apparatus according to the third aspect, a vehicle in which the vehicle-mounted network is installed may be equipped with a plurality of switch units, each of which switches a supplying of power to one or a plurality of corresponding vehicle-mounted devices on and off, the vehicle-mounted apparatus may further include a calculation unit configured to calculate, for each switch unit, a total of the consumption current of the one or plurality of vehicle-mounted devices connected to the switch unit, the plurality of power-supplied devices may be respectively connected to one switch unit out of the plurality of switch units, and the control unit may select the non-power-supplied device out of the plurality of power-supplied devices connected to a switch unit whose total satisfies a predetermined condition.

In this way, when the total of the current consumption of a plurality of power-supplied devices connected to a switch unit satisfies a predetermined condition, the current flowing through the switch unit can be reduced by selecting a device to which power should not be supplied out of the plurality of power-supplied devices, thereby suppressing the occurrence of failures at the switch unit. Accordingly, it is possible to improve the freedom with which a vehicle-mounted network can be reconfigured.

In a fifth aspect, in the vehicle-mounted apparatus according to the fourth aspect, the acquisition unit may further acquire tolerated current information indicating a tolerated current of each switch unit, and the control unit may set the predetermined condition, based on the tolerated current information acquired by the acquisition unit.

With this configuration, to prevent the total of the current consumption of a plurality of power-supplied devices connected to the switch unit from exceeding the tolerated current of the switch unit, it is possible to select a device to which power will not be supplied and thereby prevent the occurrence of failures at the switch unit. It is also possible, using the tolerated current information, to easily set a condition for determining whether to select a device to which power will not be supplied.

In a sixth aspect, in the vehicle-mounted apparatus according to any one of the second to the fifth aspects, the vehicle-mounted apparatus may further include a communication unit configured to communicate with the vehicle-mounted devices, the characteristics information may indicate, as the operating characteristics, an activation time until each vehicle-mounted device becomes capable of communication, and after supplying of power to the power-supplied device selected by the selection unit has commenced, the control unit may cause the communication unit to stand by to communicate with the power-supplied device until the activation time of the power-supplied device indicated by the characteristics information has elapsed and then cause the communication unit to start communication with the power-supplied device after the activation time has elapsed.

With this configuration, communication with a power-supplied device can be performed at timing when the power-supplied device has been reliably activated, which means that communication with the power-supplied devices can be started more stably.

In a seventh aspect, in the vehicle-mounted apparatus according to any one of the first to the sixth aspects, the activation method information may further indicate a location in the vehicle-mounted network of each vehicle-mounted device.

With this configuration, the location in the vehicle-mounted network of the power-supplied device that is subjected to the activation process can be identified and the power-supplied device can be more reliably activated in an appropriate manner.

In an eighth aspect, an activation control method according to an aspect of the present disclosure is an activation control method for a vehicle-mounted apparatus to be used on a vehicle-mounted network including a plurality of vehicle-mounted devices, the method including: a step of selecting a power-supplied device, which is a vehicle-mounted device to be supplied with power, out of the plurality of vehicle-mounted devices; a step of acquiring activation method information indicating an activation method of each vehicle-mounted device; and a step of performing an activation process that activates the selected power-supplied device, based on the acquired activation method information.

In this way, by activating a power supplied device selected out of the plurality of vehicle-mounted devices using the activation method information, it is possible, even when the configuration of the vehicle-mounted network has changed, to activate the power-supplied device according to the activation method indicated by the activation method information. Accordingly, it is possible to reliably activate vehicle-mounted devices in a newly configured vehicle-mounted network.

As one example, when activating a selected power-supplied device in a newly configured vehicle-mounted network, it is possible to newly acquire activation method information corresponding to the vehicle-mounted network and identify the activation method of the power-supplied device. By doing so, it is possible for the activation method information to be updated to accommodate changes in the configuration of a vehicle-mounted network.

In a ninth aspect, an activation control program according to an aspect of the present disclosure is an activation control program for use by a vehicle-mounted apparatus to be used on a vehicle-mounted network including a plurality of vehicle-mounted devices, the program causing a computer to function as: a selection unit configured to select a power-supplied device, which is a vehicle-mounted device to be supplied with power, out of the plurality of vehicle-mounted devices; an acquisition unit configured to acquire activation method information indicating an activation method of each vehicle-mounted device; and a control unit configured to perform an activation process that activates the power-supplied device selected by the selection unit, based on the activation method information acquired by the acquisition unit.

In this way, by activating a power-supplied device selected out of the plurality of vehicle mounted devices using the activation method information, it is possible, even when the configuration of the vehicle-mounted network has changed, to activate the power-supplied device according to the activation method indicated by the activation method information. Accordingly, it is possible to reliably activate vehicle-mounted devices in a newly configured vehicle-mounted network.

As one example, when activating a selected power-supplied device in a newly configured vehicle-mounted network, it is possible to newly acquire activation method information corresponding to the vehicle-mounted network and identify the activation method of the power-supplied device. By doing so, it is possible for the activation method information to be updated to accommodate changes in the configuration of a vehicle-mounted network.

Preferred embodiments of the present disclosure are described below with reference to the accompanying drawings. Note that parts that are the same or equivalent have been assigned the same reference numerals and description thereof is not repeated. Note also that the following embodiments may be freely combined, at least in part.

### Vehicle-Mounted System

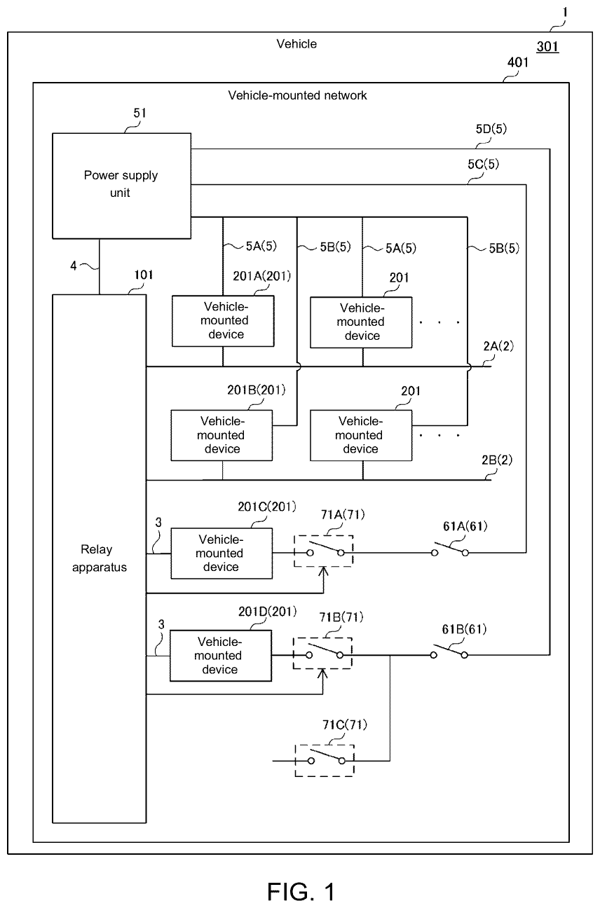

FIG. 1 is a diagram depicting an example configuration of a vehicle-mounted system according to an embodiment of the present disclosure. As depicted in FIG. 1, the vehicle-mounted system 301 includes a relay apparatus 101, a plurality of vehicle-mounted devices 201, a power supply unit 51, a plurality of power supply relays 61, and a plurality of control relays 71. The vehicle-mounted system 301 is mounted on a vehicle 1. The relay apparatus 101 is one example of a vehicle-mounted apparatus. The power supply relays 61 are examples of switch units.

As examples, the vehicle-mounted devices 201 are an autonomous driving ECU, an engine ECU, a body control ECU, a TCU (Telematics Communication Unit), a sensor, a navigation apparatus, a human machine interface, and a camera.

The relay apparatus 101 and the plurality of vehicle-mounted devices 201 construct a vehicle-mounted network 401. As examples, the plurality of vehicle-mounted devices 201 are connected to the relay apparatus 101 via CAN (Controller Area Network) (registered trademark) buses 2 that conform to CAN standard or Ethernet (registered trademark) cables 3.

A vehicle-mounted device 201A, which is one of the vehicle-mounted devices 201, is connected to the relay apparatus 101 via a CAN bus 2A, which is one of the CAN buses 2. A vehicle-mounted device 201B, which is one of the vehicle-mounted devices 201, is connected to the relay apparatus 101 via a CAN bus 2B, which is also one of the CAN buses 2.

Vehicle-mounted devices 201C and 201D, which are also vehicle-mounted devices 201, are connected to the relay apparatus 101 via the Ethernet cables 3.

Hereinafter, the vehicle-mounted devices 201 connected to the relay apparatus 101 via the CAN buses 2 are also referred to as “CAN devices”. Likewise, the vehicle-mounted devices 201 connected to the relay apparatus 101 via the Ethernet cable 3 are also referred to as “Ethernet devices”. The CAN bus 2A is also referred to as “CAN1” and the CAN bus 2B is also referred to as “CAN2”.

Each CAN device transitions from a wake-up mode to a sleep mode and from the sleep mode to the wake-up mode. In the wake-up mode, a CAN device communicates with other apparatuses in the vehicle-mounted system 301, but in the sleep mode, the CAN device stops communication with other apparatuses in the vehicle-mounted system 301. Here, the expression “sleep mode” refers to a mode in which power consumption is smaller than in wake-up mode for reasons such as some functions of the CAN device stopping, the supplying of power to the CAN device stopping, or the clock frequency of the CAN device being lowered.

Hereinafter, a vehicle-mounted device 201 that is newly added to the vehicle-mounted network 401 is also referred to as a “new device,” and the vehicle-mounted devices 201 included in the vehicle-mounted network 401 before the addition of this new device are also referred to as “existing devices”. A vehicle-mounted network 401 including a new device and a vehicle-mounted network 401 to which the connection destination of an existing device has been changed are also referred to as a “new network”.

The relay apparatus 101 is used in the vehicle-mounted network 401 including the plurality of vehicle-mounted devices 201. The relay apparatus 101 operates using power supplied from an ignition power supply of the vehicle 1, for example. The relay apparatus 101 performs relay processing to relay frames between the plurality of vehicle-mounted devices 201 connected to the relay apparatus 101.

The relay apparatus 101 and each vehicle-mounted device 201 generate frames including various information, described later, and transmit such frames to other vehicle-mounted devices 201 or to the relay apparatus 101.

Each vehicle-mounted device 201 transmits vehicle information relating to the vehicle 1 to other vehicle-mounted devices 201 or to the relay apparatus 101. The vehicle information transferred from each vehicle-mounted device 201 via a CAN bus 2 is stored in a CAN frame to which a CAN-ID (Identifier) indicating the type of data and the like is attached.

The vehicle-mounted devices 201 in the vehicle-mounted system 301 communicate with each other to provide various services on the vehicle-mounted network 401.

As one example, assume that a service for controlling the timing at which headlights are turned on is executed on the vehicle-mounted network 401. Here, a sensor, which is a vehicle-mounted device 201, transmits sensor information, which relates to the running state or state of the periphery of the vehicle 1, via the relay apparatus 101 to a body control ECU, which is another vehicle-mounted device 201. The body control ECU controls the timing at which the headlights of the vehicle 1 are turned on using the sensor information received from the sensor.

The power supply unit 51 supplies electric power in the vehicle 1. As examples, the power supply unit 51 includes an ignition power supply, an accessory power supply, and a battery.

The power supply unit 51 is connected to the relay apparatus 101 via a power supply line 4. The power supply unit 51 supplies power to the relay apparatus 101 via this power supply line 4.

The power supply unit 51 is connected to each vehicle-mounted device 201 via power supply lines 5. The power supply unit 51 supplies power to the vehicle-mounted devices 201 via these power supply lines 5.

The battery in the power supply unit 51 is connected to each vehicle-mounted device 201 connected to the CAN bus 2A via power supply lines 5A for example, which are some of the power supply lines 5. Each vehicle-mounted device 201 connected to the CAN bus 2A operates using power supplied by the battery.

The battery in the power supply unit 51 is connected to each vehicle-mounted device 201 connected to the CAN bus 2B via power supply lines 5B for example, which are also some of the power supply lines 5. Each vehicle-mounted device 201 connected to the CAN bus 2B operates using power supplied by the battery.

The accessory power supply of the power supply unit 51 is connected to a vehicle-mounted device 201C via a power supply line 5C for example, which is also one of the power supply lines 5. The ignition power supply in the power supply unit 51 is connected to a vehicle-mounted device 201D via a power supply line 5D, for example, which is also one of the power supply lines 5.

The power supply relays 61 each switch whether power is supplied to one or a plurality of corresponding vehicle-mounted devices 201 in the vehicle 1 where the vehicle-mounted network 401 is installed.

In FIG. 1, the power supply relay 61A, which is one of the power supply relays 61, is a relay for an accessory power supply. In more detail, the power supply relay 61A is provided on the power supply line 5C that connects the vehicle-mounted device 201C and the accessory power supply. The state of the power supply relay 61A is the on state when the accessory power supply of the vehicle 1 has transitioned from the off state to the on state. In this case, the vehicle-mounted device 201C operates using power supplied by the accessory power supply.

The power supply relay 61B, which is one of the power supply relays 61, is a relay for an ignition power supply. In more detail, the power supply relay 61B is provided on the power supply line 5D that connects the vehicle-mounted device 201D and the ignition power supply. The state of the power supply relay 61B is the on state when the ignition power supply of the vehicle 1 has transitioned from the off state to the on state. In this case, the vehicle-mounted device 201D operates using power supplied by the ignition power supply.

The control relays 71 switch between the on state and the off state under the control of a control unit 24 of the relay apparatus 101, which will be described later. As one example, the vehicle-mounted system 301 includes control relays 71A, 71B, and 71C as such control relays 71.

The control relay 71A is connected between the vehicle-mounted device 201C and the power supply relay 61A. As one example, the state of the control relay 71A is the off state when the accessory power supply of the vehicle 1 has transitioned from the off state to the on state.

The control relay 71B is connected between the vehicle-mounted device 201D and the power supply relay 61B. The control relay 71C is not connected to a vehicle-mounted device 201. As one example, the states of the control relays 71B and 71C are the off state when the ignition power supply of the vehicle 1 has transitioned from the off state to the on state.

Note that the vehicle-mounted system 301 is not limited to a configuration provided with two CAN buses 2, and may be a configuration provided with one CAN bus 2 or three or more CAN buses 2.

The plurality of vehicle-mounted devices 201 are not limited to being connected to the relay apparatus 101 via the CAN buses 2 and the Ethernet cables 3, and may be connected to the relay apparatus 101 via buses that conform to a communication standard, as examples, CAN FD (CAN with Flexible Data Rate), FlexRay (registered trademark), MOST (Media Oriented System Transport) (registered trademark), and LIN (Local Interconnect Network).

### Relay Apparatus

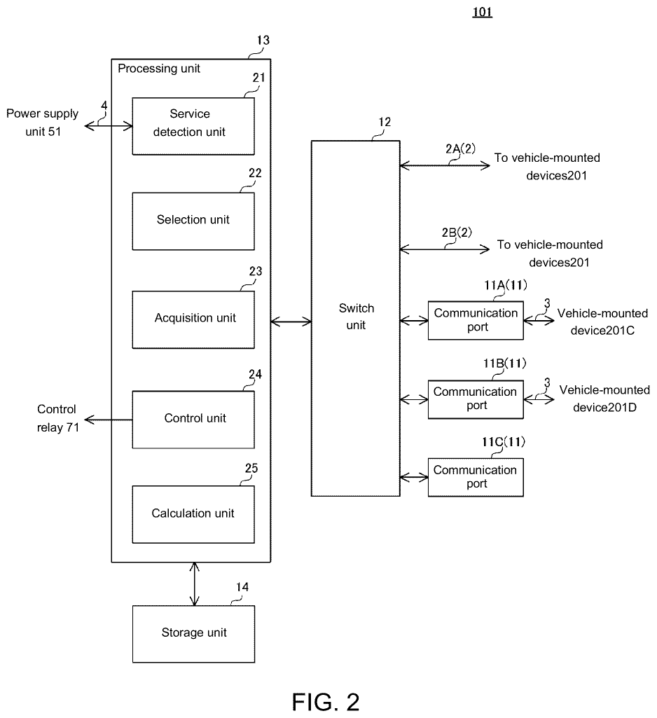

FIG. 2 is a diagram depicting an example configuration of a relay apparatus according to an embodiment of the present disclosure. As depicted in FIG. 2, the relay apparatus 101 includes a plurality of communication ports 11, a switch unit 12, a processing unit 13, and a storage unit 14. The processing unit 13 includes a service detection unit 21, a selection unit 22, an acquisition unit 23, a control unit 24, and a calculation unit 25. As one example, one or both of the switch unit 12 and the processing unit 13 are realized by a processing circuit including one or more processors. One example of the storage unit 14 is non-volatile memory included in such processing circuit. The switch unit 12 is one example of a communication unit.

The communication ports 11 are terminals to which the Ethernet cables 3 can be connected. Each communication port 11 is connected via an Ethernet cable 3 to a corresponding vehicle-mounted device 201.

As a specific example, the relay apparatus 101 includes communication ports 11A, 11B, and 11C as the communication ports 11. The communication port 11A is connected to the vehicle-mounted device 201C via an Ethernet cable 3, and the communication port 11B is connected to the vehicle-mounted device 201D via an Ethernet cable 3.

### Switch Unit

As one example, the switch unit 12 includes a plurality of terminals, not illustrated, that are respectively connected to the plurality of communication ports 11. A unique port number is assigned to each terminal.

In this example, the port numbers of the terminals connected to the communication ports 11A, 11B, and 11C are respectively “#1”, “#2”, and “#3”.

The switch unit 12 communicates with each of the vehicle-mounted devices 201. In more detail, the switch unit 12 relays frames transmitted and received between the vehicle-mounted devices 201.

The switch unit 12 is capable of performing relay processing which involves conversion between communication protocols. In more detail, when the switch unit 12 has received a frame that conforms to the CAN communication standard from a CAN device, the switch unit 12 changes the format of the received frame to a format that conforms to Ethernet communication standard and transmits the reformatted frame to an Ethernet device according to the Ethernet communication standard.

When the switch unit 12 has received a frame that conforms to Ethernet communication standard from an Ethernet device, the switch unit 12 changes the format of the received frame to a format that conforms to CAN communication standard and transmits the reformatted frame to a CAN device according to the CAN communication standard.

The switch unit 12 is also capable of performing relay processing that does not involve conversion of communication protocol. In more detail, when the switch unit 12 has received a frame that conforms to Ethernet communication standard from an Ethernet device, the switch unit 12 transmits the received frame to another Ethernet device according to the Ethernet communication standard.

When the switch unit 12 has received a frame that conforms to CAN communication standard from a CAN device, the switch unit 12 transmits the received frame to another CAN device according to the CAN communication standard.

### Control Unit

The control unit 24 controls the transition by a CAN device to the wake-up mode. As a specific example, when a CAN device operating in the sleep mode is a CAN device to be woken up, the control unit 24 creates a CAN frame including a CAN-ID and a wake-up request. The control unit 24 then transmits the created CAN frame via the switch unit 12 and a CAN bus 2 to the plurality of CAN devices connected to that CAN bus 2.

When a CAN device has received a wake-up request from the relay apparatus 101, the CAN device transitions to the wake-up mode.

In more detail, when a CAN device has received a CAN frame from the relay apparatus 101, the CAN device confirms whether its own CAN-ID is included in the CAN frame. As described earlier, when the operation mode of a CAN device is the sleep mode, although some functions of the CAN device will stop, the CAN device will still be capable of receiving CAN frames.

A CAN device operating in the sleep mode discards any CAN frames that do not include its own CAN-ID. On the other hand, when a CAN device operating in the sleep mode has received a CAN frame including its own CAN-ID, the CAN device activates a power supply IC (Integrated Circuit) (not illustrated) provided in that CAN device and transitions to the wake-up mode. By doing so, the CAN device uses the output voltage of the power supply IC to communicate with other apparatuses in the vehicle-mounted system 301. In this case, the activation method of the CAN device is “communication”.

The control unit 24 performs operation control to switch a control relay 71 connected to an Ethernet device from the off state to the on state. As a result, the Ethernet device in question is supplied with power from the power supply unit 51 and starts operating. That is, the relay apparatus 101 activates an Ethernet device by controlling the control relay 71 connected to that Ethernet device to switch from the off state to the on state. For this case, the activation method of the Ethernet device is “relay.” Note that the relay apparatus 101 may activate a vehicle-mounted device 201 according to an activation method aside from “communication” and “relay.”

### Problem to be Solved

In the vehicle-mounted network 401, a new vehicle-mounted device 201 may be added to execute a service that meets the needs of the user.

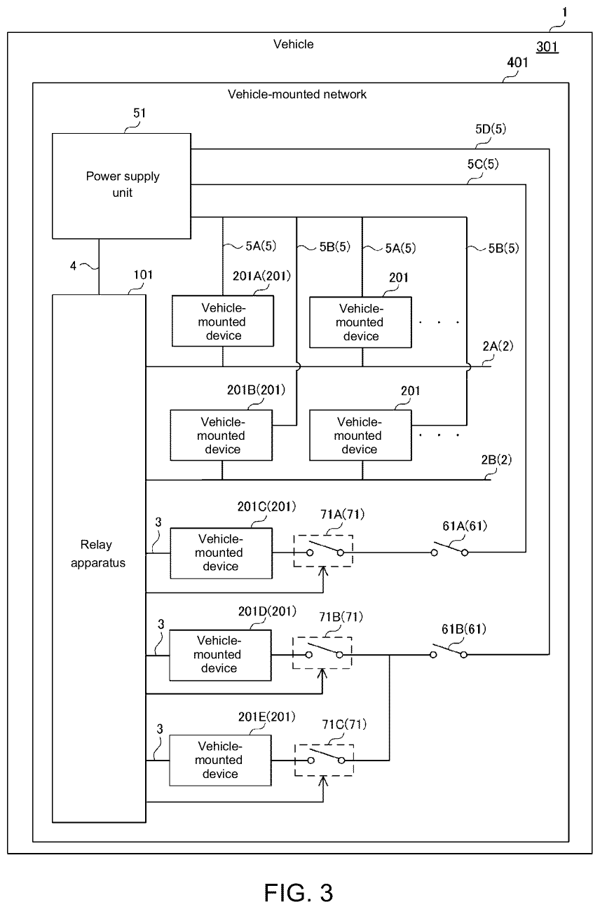

FIG. 3 is a diagram depicting an example configuration of a new network in a vehicle-mounted system according to an embodiment of the present disclosure. FIG. 3 depicts the configuration of a vehicle-mounted network 401 where a new vehicle-mounted device 201E has been added to the vehicle-mounted network 401 depicted in FIG. 1. That is, the vehicle-mounted device 201E is one example of a new device.

As depicted in FIGS. 2 and 3, the vehicle-mounted device 201E is connected to the communication port 11C of the relay apparatus 101 via an Ethernet cable 3, for example.

The vehicle-mounted device 201E is connected to the power supply relay 61B via the control relay 71C. That is, the activation method of the vehicle-mounted device 201E is “relay”. In this way, even when the vehicle-mounted device 201E has been newly added to the vehicle-mounted network 401, it is desirable for the vehicle-mounted device 201E to be reliably activated in keeping with the connection destination of the vehicle-mounted device 201E.

In addition, in the vehicle-mounted network 401, there are cases where the connection destinations of existing devices is changed in order to execute services that meet the needs of the user.

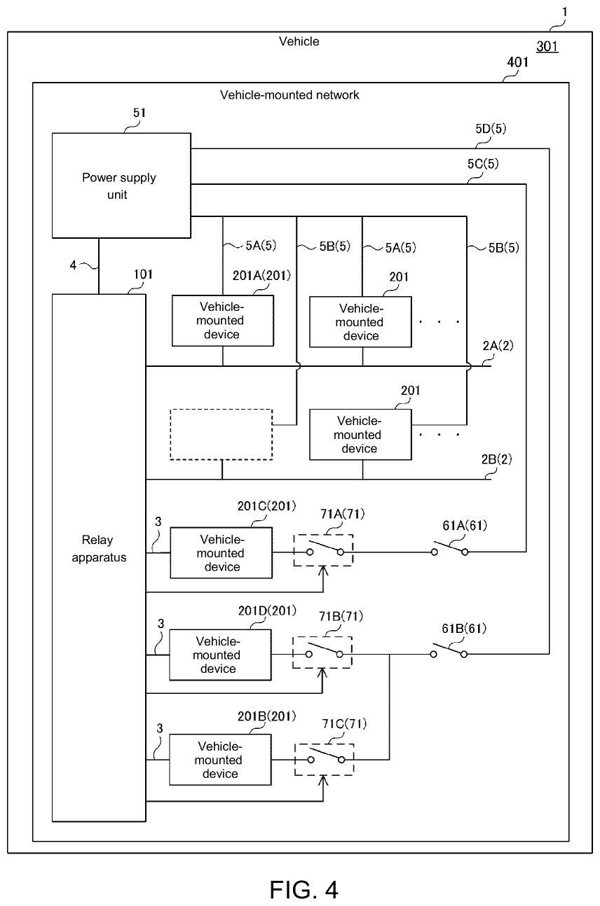

FIG. 4 is a diagram depicting another example configuration of a new network in the vehicle-mounted system according to the embodiment of the present disclosure. FIG. 4 depicts the configuration of the vehicle-mounted network 401 where the connection destination of the vehicle-mounted device 201B has been changed.

As depicted in FIGS. 2 and 4, the vehicle-mounted device 201B is connected to the communication port 11C of the relay apparatus 101 via an Ethernet cable 3, for example. That is, in the new network depicted in FIG. 4, the connection destination of the vehicle-mounted device 201B is changed from the CAN bus 2B to an Ethernet cable 3. Note that the connection destination of the vehicle-mounted device 201B may be changed from the CAN bus 2B to the CAN bus 2A. The connection destination of a vehicle-mounted device 201 connected to a communication port 11 of the relay apparatus 101 may also be changed to a different communication port 11.

The vehicle-mounted device 201B is connected to the power supply relay 61B via the control relay 71C. That is, in the new network depicted in FIG. 4, the activation method of the vehicle-mounted device 201B is changed from “communication” to “relay” in keeping with the change in the connection destination of the vehicle-mounted device 201B.

In this way, even when the connection destination of a vehicle-mounted device 201 has changed in the vehicle-mounted network 401 or the activation method of a vehicle-mounted device 201 has been changed, it is desirable for such vehicle-mounted device 201 to be activated reliably.

A tolerated current is also set for each power supply relay 61. In the new network depicted in FIG. 4, the number of vehicle-mounted devices 201 connected to the power supply relay 61B increases due to the vehicle-mounted device 201B having been connected to the power supply relay 61B. In this case, the current flowing through the power supply relay 61B is larger than the current flowing through the power supply relay 61B depicted in FIG. 1, and may exceed the tolerated current of the power supply relay 61B. For this reason, when the activation method of a vehicle-mounted device 201 has changed from “communication” to “relay,” it is necessary to prevent the current flowing through the power supply relay 61 from exceeding the tolerated current.

When the activation method of a vehicle-mounted device 201 is “communication,” the activation time until the vehicle-mounted device 201 is capable of communication is the activation time of a power supply IC provided in that vehicle-mounted device 201. This activation time is several tens of milliseconds, for example.

On the other hand, when the activation method of a vehicle-mounted device 201 is “relay”, the activation time until the vehicle-mounted device 201 becomes capable of communication is the sum of the time required for the control relay 71 to transition from the off state to the on state and the time taken for the vehicle-mounted device 201 to activate starting from the supplying of power from the power supply unit 51. This activation time is several hundred milliseconds, for example.

In this way, when the activation method of a vehicle-mounted device 201 is changed from “communication” to “relay,” the time until that vehicle-mounted device 201 becomes capable of communication increases, so that if the relay apparatus 101 attempts to start communication with a vehicle-mounted device 201 when such vehicle-mounted device 201 has not been activated, the communication may fail.

As a countermeasure, the relay apparatus 101 according to the embodiment of the present disclosure solves this problem using the following configuration and operation.

### Configuration of Relay Apparatus

### Service Detection Unit

Referring back to FIG. 2, the service detection unit 21 in the relay apparatus 101 detects the type of services executed on the vehicle-mounted network 401.

As a detailed example, the storage unit 14 stores service information, not illustrated, indicating, for each service, a start condition and an end condition of that service.

When the service detection unit 21 has determined that the state of the power supply unit 51 satisfies a predetermined start condition, the service detection unit 21 refers to the service information in the storage unit 14 to detect the service corresponding to the start condition as the type of service (hereinafter also referred to as the “executed service”) to be executed on the vehicle-mounted network 401.

As a detailed example, the service detection unit 21 detects whether the accessory power supply is on or off by periodically monitoring the output voltage of the accessory power supply of the power supply unit 51. If the measured voltage is equal to or greater than a predetermined threshold, the service detection unit 21 determines that the accessory power supply is on, and if the measured voltage is less than the threshold, the service detection unit 21 determines that the accessory power supply is off. When the service detection unit 21 has determined that the accessory power supply is in the on state, the service detection unit 21 detects, as the executed service, a service that uses the vehicle-mounted devices 201 connected to the power supply relay 61A.

The service detection unit 21 also detects for example whether the ignition power supply is on or off by periodically monitoring the output voltage of the ignition power supply of the power supply unit 51. If the measured voltage is equal to or greater than a predetermined threshold, the service detection unit 21 determines that the ignition power supply is on, and if the measured voltage is less than the threshold, the service detection unit 21 determines that the ignition power supply is off. When the service detection unit 21 has determined that the ignition power supply is in the on state, the service detection unit 21 detects, as an executed service, a service that uses the vehicle-mounted devices 201 connected to the power supply relay 61B.

The service detection unit 21 outputs detection information indicating the detection result to the selection unit 22. Note that as one example, the service detection unit 21 may receive, via the switch unit 12, type information indicating a type of service desired by the user from a navigation apparatus or the like, not illustrated, provided in the vehicle 1. In this case, the service detection unit 21 outputs the received type information to the selection unit 22 as detection information.

### Selection Unit

When the selection unit 22 has received detection information from the service detection unit 21, the selection unit 22 performs a selection process to select, out of the plurality of vehicle-mounted devices 201, the vehicle-mounted devices 201 that execute the type of service indicated by the detection information.

In more detail, the selection unit 22 selects the vehicle-mounted devices 201 to which power should be supplied (hereinafter also referred to as “power-supplied devices”) out of the plurality of vehicle-mounted devices 201. Alternatively, the selection unit 22 selects the vehicle-mounted devices 201 to which the supplying of power should be cut off (hereinafter also referred to as “cut-off devices”) out of the plurality of vehicle-mounted devices 201.

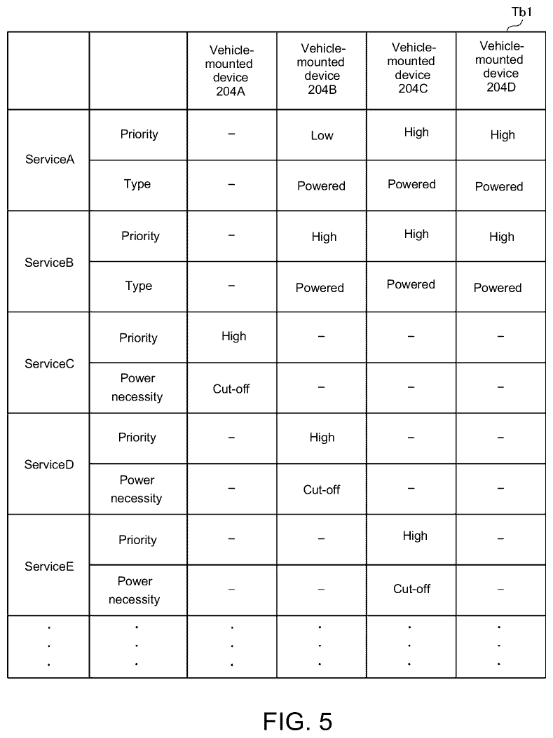

FIG. 5 is a diagram depicting one example of a device selection table stored in the relay apparatus according to the embodiment of the present disclosure.

As depicted in FIGS. 2 and 5, the storage unit 14 stores a device selection table Tb1 indicating power-supplied devices or cut-off devices for each service. This device selection table Tb1 is registered in the storage unit 14 by a manufacturer of the vehicle 1 when the vehicle 1 leaves the factory, for example.

In the device selection table Tb1, the power-supplied devices when service A and service B are being executed are the vehicle-mounted device 201B, the vehicle-mounted device 201C, and the vehicle-mounted device 201D. The cut-off device when service C is being executed is the vehicle-mounted device 201A. The cut-off device when service D is being executed is the vehicle-mounted device 201B. The cut-off device when service E is being executed is the vehicle-mounted device 201C.

When the selection unit 22 has received detection information from the service detection unit 21, the selection unit 22 reads out the device selection table Tb1 in the storage unit 14. The selection unit 22 then refers to the device selection table Tb1 to select power-supplied devices or cut-off devices that correspond to the service that corresponds to the type indicated by the detection information. The selection unit 22 outputs the selection result to the acquisition unit 23.

The device selection table Tb1 further indicates the priority of the vehicle-mounted devices 201 for each service. In the device selection table Tb1, the priority of the vehicle-mounted device 201B when service A is being executed is low, and the priority of the vehicle-mounted devices 201C and 201D when service A is being executed is high. The priority of the vehicle-mounted devices 201B, 201C, and 201D when service B is being executed is high. The priority of the vehicle-mounted device 201A when service C is being executed is high. The priority of the vehicle-mounted device 201B when service D is being executed is high. The priority of the vehicle-mounted device 201C when service E is being executed is high.

In the device selection table Tb1, the vehicle-mounted device 201B is a power-supplied device when service A is being executed and is a cut-off device when service D is being executed. As one example, when the service types indicated by the detection information received from the service detection unit 21 are service A and service D, the selection unit 22 refers to the device selection table Tb1 to confirm the priority of the vehicle-mounted device 201B when service A is being executed and the priority of the vehicle-mounted device 201B when service D is being executed. Since the priority of the vehicle-mounted device 201B when service A is being executed is low and the priority of the vehicle-mounted device 201B when service D is being executed is high, the selection unit 22 selects the vehicle-mounted device 201B as a cut-off device.

If a vehicle-mounted device 201 is a high priority power-supplied device when a certain service is being executed and is also a high priority cut-off device when another service is being executed, the vehicle-mounted device 201 is selected as a cut-off device, for example.

As one example, in the device selection table Tb1, the vehicle-mounted device 201B has a high priority when executing both service B and service D. When the types of services indicated by the detection information received from the service detection unit 21 are service B and service D, the selection unit 22 selects the vehicle-mounted device 201B as a cut-off device and not a power-supplied device.

### Acquisition Unit

The acquisition unit 23 acquires activation method information indicating the activation method of each vehicle-mounted device 201 and the location of each vehicle-mounted device 201 in the vehicle-mounted network 401 (hereinafter also referred to as the “connection location”).

In more detail, the storage unit 14 stores an activation table Tb2 including activation method information. The activation table Tb2 is registered in the storage unit 14 by the manufacturer of the vehicle 1 when the vehicle 1 leaves the factory, for example.

When the acquisition unit 23 has received a selection result indicating the power-supplied devices from the selection unit 22, the acquisition unit 23 reads the activation table Tb2 from the storage unit 14. The acquisition unit 23 then refers to the activation table Tb2 to identify the activation methods and the connection locations of the power-supplied devices.

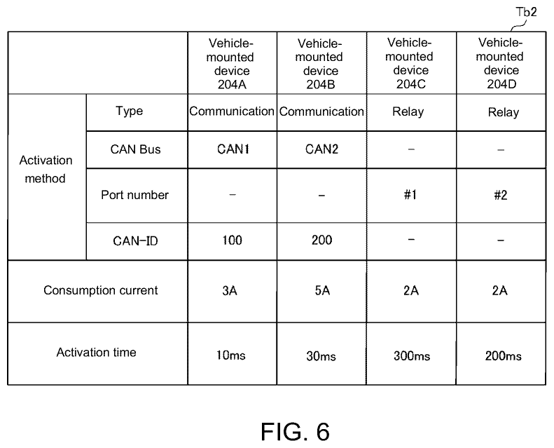

FIG. 6 is a diagram depicting an example of an activation table stored in the relay apparatus according to the embodiment of the present disclosure.

As depicted in FIG. 6, in the activation table Tb2, the activation method of the vehicle-mounted device 201A and the vehicle-mounted device 201B is “communication”. The activation method of the vehicle-mounted device 201C and the vehicle-mounted device 201D is “relay”.

The activation table Tb2 indicates, as the connection locations, the CAN buses 2 to which vehicle-mounted devices 201 are connected and the port numbers of the communication ports 11 to which such vehicle-mounted devices 201 are connected.

In the activation table Tb2, the CAN bus 2 to which the vehicle-mounted device 201A is connected is “CAN1”. The CAN bus 2 to which the vehicle-mounted device 201B is connected is “CAN2”. The port number of the communication port 11 to which the vehicle-mounted device 201C is connected is “#1”. The port number of the communication port 11 to which the vehicle-mounted device 201D is connected is “#2”.

The activation table Tb2 further indicates the CAN-IDs of CAN frames transmitted from the vehicle-mounted devices 201 whose start-up method is “communication”. In the start-up table Tb2, the CAN-ID of the CAN frames transmitted from the vehicle-mounted devices 201A is “100,” and the CAN-ID of the CAN frames transmitted from the vehicle-mounted device 201B is “200.”

As one example, the acquisition unit 23 further acquires characteristics information indicating the operating characteristics of each of the vehicle-mounted devices 201. As a detailed example, the activation table Tb2 stored in the storage unit 14 and acquired by the acquisition unit 23 further includes this characteristics information.

Here, the characteristics information included in the activation table Tb2 indicates, as the operating characteristics, the current consumption of each vehicle-mounted device 201 and the startup time required for each vehicle-mounted device 201 to become capable of communication.

In the activation table Tb2, the current consumption of the vehicle-mounted device 201A is “3A”, and the activation time until the vehicle-mounted device 201A becomes capable of communication is “10 ms”. The current consumption of the vehicle-mounted device 201B is “5A”, and the activation time until the vehicle-mounted device 201B becomes capable of communication is “30 ms”. The current consumption of the vehicle-mounted device 201C is “2A”, and the activation time until the vehicle-mounted device 201C becomes capable of communication is “300 ms”. The current consumption of the vehicle-mounted device 201D is “2A”, and the activation time until the vehicle-mounted device 201D becomes capable of communication is “200 ms”.

When the acquisition unit 23 has received a selection result indicating power-supplied devices from the selection unit 22, the acquisition unit 23 reads out the activation table Tb2 in the storage unit 14. The acquisition unit 23 then refers to the startup table Tb2 to identify the operating characteristics of the power-supplied devices indicated by the selection result received from the selection unit 22, in more detail, the current consumption and startup time of the power-supplied devices.

When the identified activation method is “relay”, the acquisition unit 23 outputs control information indicating the activation method, the identified connection location, the current consumption, and the activation time to the control unit 24.

If the identified startup method is “communication”, the acquisition unit 23 outputs control information indicating the startup method, the identified connection location, the CAN-ID, the current consumption, and the startup time to the control unit 24.

When the selection result received from the selection unit 22 indicates a plurality of power-supplied devices, the acquisition unit 23 outputs control information on each of the power-supplied devices to the control unit 24. In other words, when a plurality of power-supplied devices have been selected by the selection unit 22, the acquisition unit 23 outputs a plurality of pieces of control information to the control unit 24. As examples, the acquisition unit 23 outputs a plurality of pieces of control information indicating that the activation method is “relay” or a plurality of pieces of control information indicating that the activation method is “communication” to the control unit 24. Note that as another example, the acquisition unit 23 may output one or more pieces of control information indicating that the activation method is “relay” and one or more pieces of control information indicating that the activation method is “communication” to the control unit 24.

### Updating of Device Selection Table and Activation Table

The device selection table Tb1 and the activation table Tb2 may for example be updatable. As a detailed example, if the configuration of the vehicle-mounted network 401 is changed after the vehicle 1 has left the factory, a dealer updates the device selection table Tb1 and the activation table Tb2 in the storage unit 14. In more detail, the dealer updates the device selection table Tb1 and the activation table Tb2 in the storage unit 14 for example when a new device has been added to the vehicle-mounted network 401, when the connection destination of an existing device has been changed, or when the activation method of an existing device has been changed.

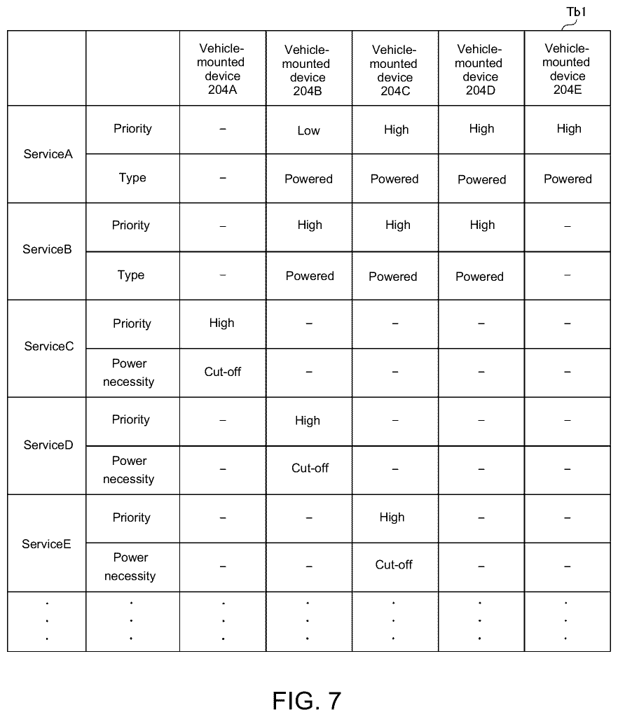

FIG. 7 is a diagram illustrating an example of an updated device selection table Tb1 stored in the relay apparatus according to the embodiment of the present disclosure. FIG. 7 depicts one example of the device selection table Tb1 when the vehicle-mounted device 201E has been added to the vehicle-mounted network 401.

As depicted in FIG. 7, in the updated device selection table Tb1, the vehicle-mounted device 201E is registered as a power-supplied device when service A is being executed. Information indicating that the vehicle-mounted device 201E has high priority when service A is being executed is also registered.

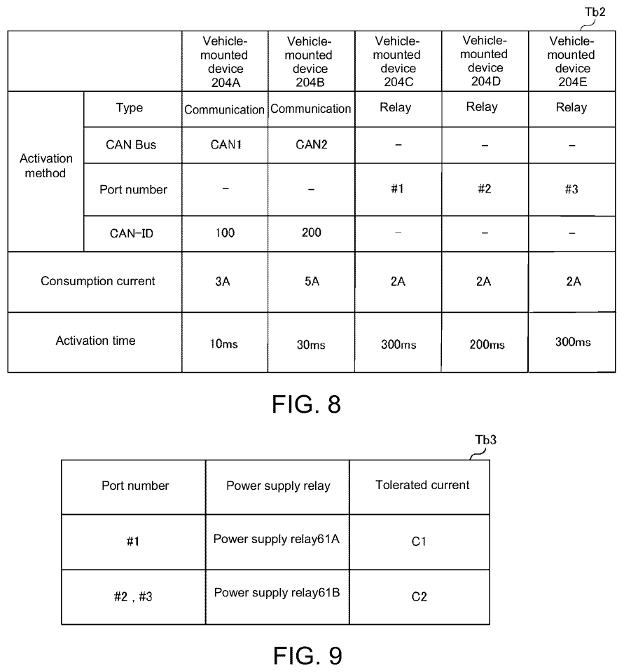

FIG. 8 is a diagram depicting one example of an updated activation table Tb2 stored in the relay apparatus according to the embodiment of the present disclosure. FIG. 7 depicts one example of the activation table Tb2 when the vehicle-mounted device 201E has been added to the vehicle-mounted network 401.

As depicted in FIG. 8, in the updated activation table Tb2, information indicating that the port number of the communication port 11 to which the vehicle-mounted device 201E is connected is “#3” is registered. Information indicating that the current consumption of the vehicle-mounted device 201E is “2A” and that the activation time until the vehicle-mounted device 201C becomes capable of communication is “300 ms” is also registered.

### Activation Process

The control unit 24 performs an activation process to activate the power-supplied devices selected by the selection unit 22, based on the activation method information and characteristics information acquired by the acquisition unit 23.

In more detail, when the control unit 24 has received the control information from the acquisition unit 23, the control unit 24 activates the power-supplied devices, based on the activation method indicated by the control information.

In more detail, when the activation method indicated by the control information received from the acquisition unit 23 is “relay” and the connection location indicated by the control information is a port number, the control unit 24 identifies the power-supplied device connected to the communication port 11 with that port number. The control unit 24 then performs control to switch the control relay 71 connected to the identified power-supplied device from the off state to the on state. As a result, the power-supplied device is supplied with power from the power supply unit 51 and is activated.

When the activation method indicated by the control information received from the acquisition unit 23 is “communication” and the connection location indicated by the control information is a CAN bus 2, the control unit 24 creates a CAN frame including the CAN-ID indicated by the control information and a wake-up request. The control unit 24 then transmits the created CAN frame via the switch unit 12 and that CAN bus 2 to the plurality of CAN devices connected to the CAN bus 2.

When one of the plurality of CAN devices receives a CAN frame including its own CAN-ID, that CAN device transitions to the wake-up mode in accordance with the wake-up request included in the CAN frame.

### Standby Control

As one example, after the supplying of power to a power supplied device selected by the selection unit 22 has commenced, the control unit 24 causes the switch unit 12 to stand by for communication with that power-supplied devices until the activation time of that power-supplied device indicated by the characteristics information has elapsed, and causes the switch unit 12 to start communicating with the power-supplied device after the activation time has elapsed.

In more detail, when the activation method indicated by the control information received from the acquisition unit 23 is “relay,” the control unit 24 outputs a standby notification, which requests a standby for communication with a power-supplied device and indicates the port number of the communication port 11 to which that power-supplied devices is connected, to the switch unit 12. In more detail, the control unit 24 switches the control relay 71 connected to the power-supplied device from the off state to the on state, and then outputs the standby notification to the switch unit 12.

When the switch unit 12 has received the standby notification from the control unit 24, the switch unit 12 stands by for communication with the power-supplied device connected to the communication port 11 with the port number indicated in the standby notification. As a detailed example, the switch unit 12 stands by for transmission of a frame for controlling the power supplied device.

In addition, when the control unit 24 has confirmed that the activation time indicated by the control information received from the acquisition unit 23 has elapsed from the timing at which the control relay 71 connected to the power-supplied device was switched from the off state to the on state, the control unit 24 outputs a permission notification indicating that communication with the power-supplied device is permitted and the port number of the communication port 11 to which such power-supplied device is connected.

When the switch unit 12 has received the permission notification from the control unit 24, the switch unit 12 starts communication with the power-supplied device connected to the communication port 11 with the port number indicated by the permission notification.

### Selection of Power-Supplied Device Not Supplied With Power

As one example, when a plurality of power-supplied devices selected by the selection unit 22 are connected to any power supply relay 61 out of the plurality of power supply relays 61, the control unit 24 selects a power supplied device which is not to be supplied with power (hereinafter also referred to as a “non power-supplied device”) out of the plurality of power-supplied devices, based on the current consumption of each power-supplied device indicated by the characteristics information included in the activation table Tb2.

In more detail, when the control unit 24 has received a plurality of pieces of control information indicating that the activation method is “relay” from the acquisition unit 23, the control unit 24 outputs the activation method, connection location, and current consumption of the power-supplied devices indicated by each piece of control information to the calculation unit 25.

When the calculation unit 25 has received the activation method, the connection location, and current consumption of the power-supplied devices indicated by each control information from the control unit 24, the calculation unit 25 calculates, for each power supply relay 61, a total of the current consumption of the one or plurality of vehicle-mounted devices 201 connected to that power supply relay 61.

In more detail, the storage unit 14 stores a relay table Tb3 indicating the correspondence between the port numbers of the communication ports 11 and the power supply relays 61.

FIG. 9 is a diagram illustrating one example of a relay table stored in a relay apparatus according to an embodiment of the present disclosure.

As depicted in FIG. 9, in the relay table Tb3, the power supply relay 61 corresponding to the port number “#1” is the power supply relay 61A. The power supply relay 61 corresponding to the port numbers “#2” and “#3” is the power supply relay 61B. The “tolerated current” depicted in FIG. 9 will be described later.

As depicted in FIG. 2 and FIG. 9, when the calculation unit 25 has received the activation method, the connection location, and current consumption of the power supplied devices indicated by each piece of control information from the control unit 24, the calculation unit 25 reads out the relay table Tb3 in the storage unit 14. The calculation unit 25 then refers to the relay table Tb3 to identify the power supply relay 61 corresponding to the connection location in question, that is, to the port number.

The calculation unit 25 then calculates the total of the current consumption of the one or plurality of power-supplied devices connected to the identified power supply relay 61 using the current consumption indicated by each piece of control information received from the control unit 24. The calculation unit 25 notifies the control unit 24 of this calculation result.

The control unit 24 selects the non-power-supplied devices out of the plurality of power supplied devices (hereinafter also referred to as a “group of connected devices”) connected to a power supply relay 61 for which the total value of the current consumption indicated by the calculation result received from the calculation unit 25 satisfies a predetermined condition.

In more detail, the acquisition unit 23 acquires tolerated current information indicating the tolerated current of each power supply relay 61.

More specifically, the relay table Tb3 stored in the storage unit 14 further indicates the correspondence between the power supply relays 61 and their tolerated currents.

In the relay table Tb3, the tolerated current of the power supply relay 61A for the accessory power supply is “C1”, and the tolerated current of the power supply relay 61B for the ignition power supply is “C2”.

When, as described above, the activation method identified using the activation table Tb2 is “relay” and the identified connection location is a port number, the acquisition unit 23 reads out the relay table Tb3 in the storage unit 14. The acquisition unit 23 then refers to the relay table Tb3 to identify the tolerated current of the power supply relay 61 corresponding to the port number and outputs relay information indicating the identified tolerated current and the port number to the control unit 24.

As one example, the control unit 24 sets a predetermined condition for selecting non-power supplied devices, based on the tolerated current information acquired by the acquisition unit 23.

In more detail, when the control unit 24 has received relay information from the acquisition unit 23, the control unit 24 refers to the relay table Tb3 in the storage unit 14 to identify the power supply relay 61 corresponding to the port number indicated by the relay information. The control unit 24 then sets, as a predetermined condition, that the total of the current consumption of the plurality of vehicle-mounted devices 201 connected to the identified power supply relay 61 is equal to or greater than the tolerated current indicated by the relay information.

When the total of the current consumption indicated by the calculation result received from the calculation unit 25 is equal to or greater than the tolerated current, the control unit 24 refers to a power supplying priority table Tb4 in the storage unit 14 and selects a non-power-supplied device. Note that the control unit 24 may set, as the predetermined condition, that the total of the current consumption indicated by the calculation result received from the calculation unit 25 is equal to or greater than a value produced by subtracting a predetermined margin from the tolerated current.

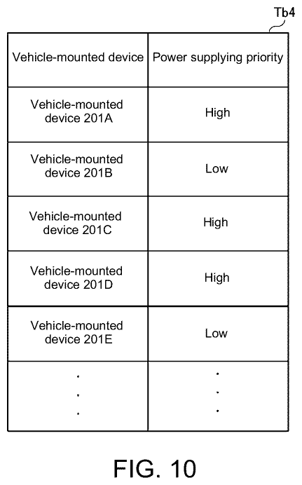

FIG. 10 is a diagram depicting one example of a power supplying priority table stored by a relay apparatus according to an embodiment of the present disclosure.

As depicted in FIG. 10, the power supplying priority table Tb4 indicates the priority of each vehicle-mounted device 201. In the power supply priority table Tb4, the vehicle-mounted devices 201A, 201C, and 201D have high priorities, and the vehicle-mounted devices 201B and 201E have low priorities.

As one example, in the new network depicted in FIG. 3, when the total of the current consumption of the vehicle-mounted device 201D and the vehicle-mounted device 201E connected to the power supply relay 61B is equal to or greater than the tolerated current, the control unit 24 refers to the power supply priority table Tb4 and selects the vehicle-mounted device 201E, which has low priority, as a non-power-supplied device.

As another example, in the new network depicted in FIG. 4, when the total value of the current consumption of the vehicle-mounted device 201D and the vehicle-mounted device 201B connected to the power supply relay 61B is equal to or greater than the tolerated current, the control unit 24 refers to the power supply priority table Tb4 and selects the vehicle-mounted device 201B, which has low priority, as a non-power supplied device.

The control unit 24 then activates the power-supplied devices (hereinafter also referred to as “identified devices”) aside from the selected non power-supplied devices out of the plurality of power-supplied devices that compose the group of connected devices, in accordance with the activation method for the identified devices indicated in the activation table Tb2.

In the new network depicted in FIG. 3, when for example the control unit 24 has selected the vehicle-mounted device 201E as a non-power-supplied device, the control unit 24 determines that the vehicle-mounted device 201D is an identified device. The control unit 24 then activates the vehicle-mounted device 201D according to the activation method of the vehicle-mounted device 201D indicated in the activation table Tb2 in the storage unit 14. In more detail, the control unit 24 controls the control relay 71B connected to the vehicle-mounted device 201D to switch from the off state to the on state. By doing so, the vehicle-mounted device 201D is supplied with power from the power supply unit 51 and starts operating.

In the new network depicted in FIG. 4, when the control unit 24 has selected the vehicle-mounted device 201B for example as a non-power-supplied device, the control unit 24 determines that the vehicle-mounted device 201D is an identified device in the same way as for the new network depicted in FIG. 3.

On the other hand, when the total of the current consumption calculated by the calculation unit 25 is less than the tolerated current, the control unit 24 does not select a non-power-supplied device. In this case, the control unit 24 performs control to switch the plurality of control relays 71 connected to the plurality of power-supplied devices selected by the selection unit 22 from the off state to the on state.

### Service Termination

When the service detection unit 21 has determined that the state of the power supply unit 51 satisfies a predetermined termination condition, the service detection unit 21 refers to the service information described above in the storage unit 14 and outputs a termination notification, which indicates that the service corresponding to the termination condition should be terminated, to the control unit 24.

When the control unit 24 has received the termination notification from the service detection unit 21, the control unit 24 performs termination control to terminate the operation of the vehicle-mounted devices 201 corresponding to the service indicated by the termination notification.

As one example, as the termination control, the control unit 24 transmits, via the switch unit 12 and the CAN bus 2, a sleep request to CAN devices corresponding to the service indicated by the termination notification, to cause a transition in the operation mode of such CAN devices from the wake-up mode to the sleep mode.

In more detail, the control unit 24 transmits a CAN frame including the CAN-IDs indicated by the control information received from the acquisition unit 23 and a sleep request to the plurality of CAN devices connected to the CAN bus 2 indicated by the control information.

Out of the plurality of CAN devices, a CAN device that has received a CAN frame including its own CAN-ID transitions to the sleep mode in accordance with the sleep request included in the CAN frame. This causes the CAN device to stop communication with other devices in the vehicle-mounted system 301.

As one example, the control unit 24 performs, as the termination control, control to switch the control relay 71 connected to an Ethernet device corresponding to the service indicated by the termination notification from the on state to the off state. By doing so, the Ethernet device stops operating due to the supplying of power from the power supply unit 51 being cut off.

### Flow of Operation

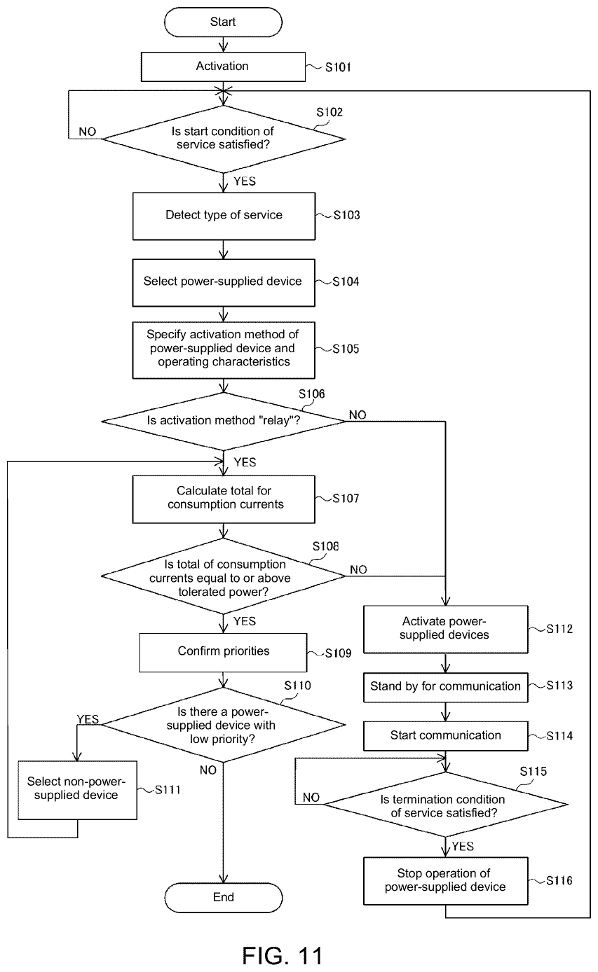

FIG. 11 is a flowchart defining an operation procedure in which a relay apparatus according to an embodiment of the present disclosure performs an activation process.

As depicted in FIG. 11, first, when the relay apparatus 101 has been supplied with power from the power supply unit 51, the relay apparatus 101 activates (step S101).

Next, if the state of the power supply unit 51 satisfies the start condition of a service (“YES” in step S102), the relay apparatus 101 detects the type of service to be executed on the vehicle-mounted network 401 (step S103).

After this, the relay apparatus 101 selects the power-supplied devices from the plurality of vehicle-mounted devices 201. As one example, as described earlier, the relay apparatus 101 refers to the device selection table Tb1 in the storage unit 14 and selects the power-supplied devices corresponding to the detected type of service. It is assumed here that the relay apparatus 101 selects a plurality of power-supplied devices (step S104).

Next, the relay apparatus 101 identifies the activation method and operating characteristics of each power-supplied device. As one example, as described earlier, the relay apparatus 101 refers to the activation table Tb2 in the storage unit 14 to identify the activation methods and the operating characteristics of the respective power-supplied devices (step S105).

After this, if the identified activation method is “relay” (“YES” in step S106), the relay apparatus 101 calculates, for each power supply relay 61, the total of the current consumption of the one or plurality of power-supplied devices connected to that power supply relay 61. It is assumed here that the relay apparatus 101 calculates the total of the current consumption of a group of connected devices, which are the plurality of power-supplied devices connected to the power supply relay 61B, out of the plurality of selected power-supplied devices (step S107).

Next, if the calculated total of the current consumption is equal to or greater than the tolerated current (“YES” in step S108), the relay apparatus 101 refers to the power supplying priority table Tb4 in the storage unit 14 to confirm the priority of each power-supplied device in the group of connected devices (step S109).

After this, when a power-supplied device with low priority is included in the group of connected devices (“YES” in step S110), the relay apparatus 101 selects such power-supplied device as a non power-supplied device (step S111).

Next, the relay apparatus 101 calculates the total of the current consumption of the power-supplied devices aside from the non-power-supplied devices in the group of connected devices (step S107), and if the calculated total of the current consumption is equal to or greater than the tolerated current (“YES” in step S108), the relay apparatus 101 confirms the priority of each power-supplied device connected to the power supply relay 61B once again (step S109).

When the plurality of power-supplied devices further include a power-supplied device with low priority (“YES” in step S110), the relay apparatus 101 newly selects such power supplied device as a non-power-supplied device (step S111).

On the other hand, when the calculated total of the current consumption is less than the tolerated current (“NO” in step S108), the relay apparatus 101 activates the power supplied devices aside from any selected non power-supplied devices in the plurality of power-supplied devices. As one example, as described earlier, the relay apparatus 101 controls the control relay 71 connected to the power-supplied devices aside from the selected non-power-supplied devices to switch from the off state to the on state (step S112).

Also, if the activation method of the identified power-supplied devices is not “relay”, that is, if the activation method is “communication” (“NO” in step S106), the relay apparatus 101 activates the plurality of power-supplied devices. As one example, as described earlier, the relay apparatus 101 transmits a CAN frame including a wake-up request to the power-supplied devices (step S112).

Next, the relay apparatus 101 stands by for communication with the power-supplied devices. As one example, as described earlier, after the relay apparatus 101 has started supplying power to the power-supplied devices, the relay apparatus 101 stands by for communication with the power-supplied devices until the activation time of the power-supplied devices indicated in the activation table Tb2 has elapsed (step S113).

After this, the relay apparatus 101 starts communication with a power-supplied device after the activation time of that power-supplied device has elapsed (step S114).

Next, when the state of the power supply unit 51 satisfies the termination condition of a service being executed (“YES” in step S115), the relay apparatus 101 stops the operation of the power-supplied devices corresponding to the service (step S116). The relay apparatus 101 then waits for the state of the power supply unit 51 to satisfy the start condition of another service (“NO” in step S102).

On the other hand, if the group of connected devices does not include a power-supplied device with low priority (“NO” in step S110), the relay apparatus 101 ends this processing.

Note that although the relay apparatus 101 is configured to include the service detection unit 21, the selection unit 22, the acquisition unit 23, the control unit 24, and the calculation unit 25 in the vehicle-mounted system 301 according to the present embodiment of the disclosure, this is not a limitation. As one example, a vehicle-mounted apparatus aside from the relay apparatus 101 may include the service detection unit 21, the selection unit 22, the acquisition unit 23, the control unit 24, and the calculation unit 25 and perform the processing described above.

Although the activation table Tb2 stored in the storage unit 14 includes activation method information and characteristics information in the relay apparatus 101 according to the embodiment of the present disclosure, this is not a limitation. As one example, in place of the activation table Tb2, the storage unit 14 may be configured to separately store a table including activation method information and a table including characteristics information.

Although the characteristics information included in the activation table Tb2 stored in the storage unit 14 of the relay apparatus 101 according to the embodiment of the present disclosure is configured to indicate, as the operating characteristics of each vehicle-mounted device 201, the current consumption of each vehicle-mounted device 201 and the activation time until each vehicle-mounted device 201 becomes capable of communication, the characteristics information is not limited to this. As one example, the characteristics information may be configured to indicate operating characteristics aside from the current consumption of each vehicle-mounted device 201 and the activation time of each vehicle-mounted device 201.

In addition, although the activation table Tb2 stored in the storage unit 14 in the relay apparatus 101 according to the embodiment of the present disclosure is configured to include characteristics information, the activation table is not limited to this. As one example, the activation table Tb2 may be configured to not include characteristics information. In this case, the control unit 24 in the relay apparatus 101 performs the activation process without using characteristics information.

Although the control unit 24 is configured to set the predetermined condition for selecting a non-power-supplied device, based on the tolerated current information acquired by the acquisition unit 23 in the relay apparatus 101 according to the embodiment of the present disclosure, the predetermined condition is not limited to being set in this way. As one example, the control unit 24 may be configured to acquire a predetermined condition registered in advance in the storage unit 14.

In addition, although for the relay apparatus 101 according to the embodiment of the present disclosure, the activation method information included in the activation table Tb2 stored in the storage unit 14 is configured to indicate the activation method of each vehicle-mounted device 201 and the location of each vehicle-mounted device 201 in the vehicle-mounted network 401, the activation method information is not limited to this. As one example, the activation method information may be configured not to indicate the location of each vehicle-mounted device 201 in the vehicle-mounted network 401.

Note that the embodiments disclosed above are exemplary in all respects and should not be regarded as limitations on the present disclosure. The scope of the present disclosure is indicated by the range of the patent claims, not the embodiments described above, and is intended to include all changes within the meaning and scope of the patent claims and their equivalents.

Each process (each function) in the embodiment described above is realized by a processing circuitry including one or more processors. The processing circuitry described above may be composed of an integrated circuit or the like in which one or a plurality of memories, various analog circuits, and various digital circuits are combined together with the one or plurality of processors. The one or plurality of memories store programs (instructions) that cause the one or plurality of processors to execute the processes described above. The one or plurality of processors described above may execute the respective processes according to the program read from the one or plurality of memories, or may execute the respective processes according to a logic circuit designed in advance to execute the respective processes. The processors mentioned above may be any of a variety of processors suited to computer control, such as a CPU (Central Processing Unit), a GPU (Graphics Processing Unit), a DSP (Digital Signal Processor), an FPGA (Field Programmable Gate Array), and an ASIC (Application Specific Integrated Circuit). Note that the plurality of processors that are physically separated may cooperate with each other to execute the above processes. As one example, processors that are installed in physically separated computers may execute the above processes by cooperating with each other via a network, such as a LAN (Local Area Network), a WAN (Wide Area Network), or the Internet. The program mentioned above may be installed into the memory from an external server apparatus or the like via the network, or may be distributed having been stored on a recording medium, such as a CD-ROM (Compact Disc Read Only Memory), a DVD-ROM (Digital Versatile Disc Read Only Memory), or a semiconductor memory, and then installed into the memory from the recording medium.

The above description also includes the following additional characteristics.

### Appendix 1

A vehicle-mounted apparatus used on a vehicle-mounted network including a plurality of vehicle-mounted devices, comprising a processing circuit,
wherein the processing circuit:
selects a power-supplied device, which is a vehicle-mounted device to be supplied with power, out of the plurality of vehicle-mounted devices;
acquires activation method information indicating an activation method of each vehicle-mounted device; and
performs an activation process to activate the selected power-supplied device, based on the acquired activation method information.

### Appendix 2

A vehicle-mounted system comprising: a plurality of vehicle-mounted devices; and a vehicle-mounted apparatus used on a vehicle-mounted network including the plurality of vehicle-mounted devices,
wherein the vehicle mounted apparatus includes:
a selection unit configured to select a power-supplied device, which is a vehicle-mounted device to be supplied with power, out of the plurality of vehicle-mounted devices;
an acquisition unit configured to acquire activation method information indicating an activation method of each vehicle-mounted device; and
a control unit configured to perform an activation process to activate the power-supplied device selected by the selection unit, based on the activation method information acquired by the acquisition unit.

1. A vehicle-mounted apparatus to be used on a vehicle-mounted network including a plurality of vehicle-mounted devices, the vehicle-mounted apparatus comprising:
a selection unit configured to select a power-supplied device, which is a vehicle-mounted device to be supplied with power, out of the plurality of vehicle-mounted devices;
an acquisition unit configured to acquire activation method information indicating an activation method of each vehicle-mounted device; and
a control unit configured to perform an activation process that activates the power-supplied device selected by the selection unit, based on the activation method information acquired by the acquisition unit.

2. The vehicle-mounted apparatus according to claim 1,
wherein the acquisition unit further acquires characteristics information indicating operating characteristics of each vehicle-mounted device, and
the control unit performs the activation process, based on the activation method information and the characteristics information acquired by the acquisition unit.

3. The vehicle-mounted apparatus according to claim 2,
wherein the characteristics information indicates a consumption current of each vehicle-mounted device as the operating characteristics,
the selection unit selects a plurality of the power-supplied devices out of the plurality of vehicle-mounted devices,
the control unit selects, based on the consumption current of each power-supplied device indicated by the characteristics information, a non-power-supplied device, which is a power-supplied device that is not to be supplied power, out of the plurality of power-supplied devices, and
the control unit activates identified devices, which are power-supplied devices out of the plurality of power-supplied devices aside from the selected non-power-supplied device, according to the activation methods of the identified devices indicated by the activation method information.

4. The vehicle-mounted apparatus according to claim 3,
wherein a vehicle in which the vehicle-mounted network is installed is equipped with a plurality of switch units, each of which switches a supplying of power to one or a plurality of corresponding vehicle-mounted devices on and off,
the vehicle-mounted apparatus further comprises a calculation unit configured to calculate, for each switch unit, a total of the consumption current of the one or plurality of vehicle-mounted devices connected to the switch unit,
the plurality of power-supplied devices are respectively connected to one switch unit out of the plurality of switch units, and
the control unit selects the non-power-supplied device out of the plurality of power-supplied devices connected to a switch unit whose total satisfies a predetermined condition.

5. The vehicle-mounted apparatus according to claim 4,
wherein the acquisition unit further acquires tolerated current information indicating a tolerated current of each switch unit, and
the control unit sets the predetermined condition, based on the tolerated current information acquired by the acquisition unit.

6. The vehicle-mounted apparatus according to claim 2,
wherein the vehicle-mounted apparatus further comprises a communication unit configured to communicate with the vehicle-mounted devices,
the characteristics information indicates, as the operating characteristics, an activation time until each vehicle-mounted device becomes capable of communication, and
after supplying of power to the power-supplied device selected by the selection unit has commenced, the control unit causes the communication unit to stand by to communicate with the power-supplied device until the activation time of the power-supplied device indicated by the characteristics information has elapsed and then causes the communication unit to start communication with the power-supplied device after the activation time has elapsed.

7. The vehicle-mounted apparatus according to claim 1, wherein the activation method information further indicates a location in the vehicle-mounted network of each vehicle-mounted device.

8. An activation control method for a vehicle-mounted apparatus to be used on a vehicle-mounted network including a plurality of vehicle-mounted devices, the method comprising:
a step of selecting a power-supplied device, which is a vehicle-mounted device to be supplied with power, out of the plurality of vehicle-mounted devices;
a step of acquiring activation method information indicating an activation method of each vehicle-mounted device; and
a step of performing an activation process that activates the selected power-supplied device, based on the acquired activation method information.

9. An activation control program for use by a vehicle-mounted apparatus to be used on a vehicle-mounted network including a plurality of vehicle-mounted devices, the program causing a computer to function as:
a selection unit configured to select a power-supplied device, which is a vehicle-mounted device to be supplied with power, out of the plurality of vehicle-mounted devices;
an acquisition unit configured to acquire activation method information indicating an activation method of each vehicle-mounted device; and
a control unit configured to perform an activation process that activates the power-supplied device selected by the selection unit, based on the activation method information acquired by the acquisition unit.

10. The vehicle-mounted apparatus according to claim 3,
wherein the vehicle-mounted apparatus further comprises a communication unit configured to communicate with the vehicle-mounted devices,
the characteristics information indicates, as the operating characteristics, an activation time until each vehicle-mounted device becomes capable of communication, and
after supplying of power to the power-supplied device selected by the selection unit has commenced, the control unit causes the communication unit to stand by to communicate with the power-supplied device until the activation time of the power-supplied device indicated by the characteristics information has elapsed and then causes the communication unit to start communication with the power-supplied device after the activation time has elapsed.

11. The vehicle-mounted apparatus according to claim 4,
wherein the vehicle-mounted apparatus further comprises a communication unit configured to communicate with the vehicle-mounted devices,
the characteristics information indicates, as the operating characteristics, an activation time until each vehicle-mounted device becomes capable of communication, and
after supplying of power to the power-supplied device selected by the selection unit has commenced, the control unit causes the communication unit to stand by to communicate with the power-supplied device until the activation time of the power-supplied device indicated by the characteristics information has elapsed and then causes the communication unit to start communication with the power-supplied device after the activation time has elapsed.

12. The vehicle-mounted apparatus according to claim 5,
wherein the vehicle-mounted apparatus further comprises a communication unit configured to communicate with the vehicle-mounted devices,
the characteristics information indicates, as the operating characteristics, an activation time until each vehicle-mounted device becomes capable of communication, and
after supplying of power to the power-supplied device selected by the selection unit has commenced, the control unit causes the communication unit to stand by to communicate with the power-supplied device until the activation time of the power-supplied device indicated by the characteristics information has elapsed and then causes the communication unit to start communication with the power-supplied device after the activation time has elapsed.

13. The vehicle-mounted apparatus according to claim 2, wherein the activation method information further indicates a location in the vehicle-mounted network of each vehicle-mounted device.

14. The vehicle-mounted apparatus according to claim 3, wherein the activation method information further indicates a location in the vehicle-mounted network of each vehicle-mounted device.

15. The vehicle-mounted apparatus according to claim 4, wherein the activation method information further indicates a location in the vehicle-mounted network of each vehicle-mounted device.

16. The vehicle-mounted apparatus according to claim 5, wherein the activation method information further indicates a location in the vehicle-mounted network of each vehicle-mounted device.

17. The vehicle-mounted apparatus according to claim 6, wherein the activation method information further indicates a location in the vehicle-mounted network of each vehicle-mounted device.
